(19) United States
(12) Patent Application Publication
(10) Pub. No.: US 2006/0048466 A1
(43) Pub. Date: Mar. 9, 2006

(54) Systems and installation methods for a fire-resistant door jamb

(76) Inventor: Duane Darnell, Redmond, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/009,384

(22) Filed: Dec. 8, 2004

Related U.S. Application Data
(60) Provisional application No. 60/609,000, filed on Sep. 9, 2004.

(51) Int. Cl. E06B 1/04

(52) U.S. Cl. 52/204.1

(57) ABSTRACT

A fire-resistant door jamb system may incorporate wood components, intumescent material and a flexible bracket system for installing a doorjamb system in a wall.

### CROSS-REFERENCE TO RELATED APPLICATION

This application claims priority under 35 U.S.C. § 119 and applicable foreign and international law of U.S. Provisional Patent Application Ser. No. 60/609,000 filed Sep. 9, 2004 which is hereby incorporated by reference in its entirety for all purposes.

### FIELD OF THE INVENTION

The invention relates to fire-resistant door jamb systems. Particularly, jamb assemblies comprised of wood components.

### BACKGROUND

It is often necessary or desirable to install fire-resistant doors in buildings. Fire-resistant doors are typically quite heavy and require special fire-resistant jambs for support. Metal door jambs are often used in conjunction with doors consisting of fire-resistant materials. Metal jambs may be unsatisfactory aesthetically if the appearance of wood detail is desired. Accordingly, there is a need for fire-resistant door jamb systems that use wood components.

### SUMMARY

In one example, a door jamb may include a hinge leg and a strike leg connected via a header, each of the legs and header including fire-resistant wood components and integrated intumescent material.

A bracket system may be used to install a jamb in a wall. One example of a bracket system uses adjustable brackets to accommodate varying wall thickness. Another example uses reinforced coupling bracket structure connecting a fire door to the jamb and the wall via hinges. Described examples provide fire-resistant door jamb systems that achieve standard 60- and 90-minute fire rating.

### BRIEF DESCRIPTION OF THE FIGURES

FIG. 1 is a perspective view-of a fire-resistant door jamb system installed in a wall.

FIG. 2 is a perspective view of the back side of the door system shown in FIG. 1.

FIG. 3 is a partial cross-sectional view of the fire-resistant door jamb system shown in FIG. 1.

FIG. 4 is a partial cross-sectional view of an alternative fire-resistant door jamb system.

FIGS. 5 and 6 are partial cross-sectional views of a fire-resistant door jamb system installed in walls of different thickness.

FIG. 7 is a partial perspective view of a bracket device used to accommodate walls of different thickness.

FIGS. 8 and 9 are partial cross-sectional views of a fire-resistant door jamb system installed in walls of different thickness.

FIG. 10 is a partial perspective view of a bracket device used to accommodate walls of different thickness.

FIG. 11 is a cross-sectional view of a jamb leg in another example of a fire-resistant door jamb system.

### DESCRIPTION

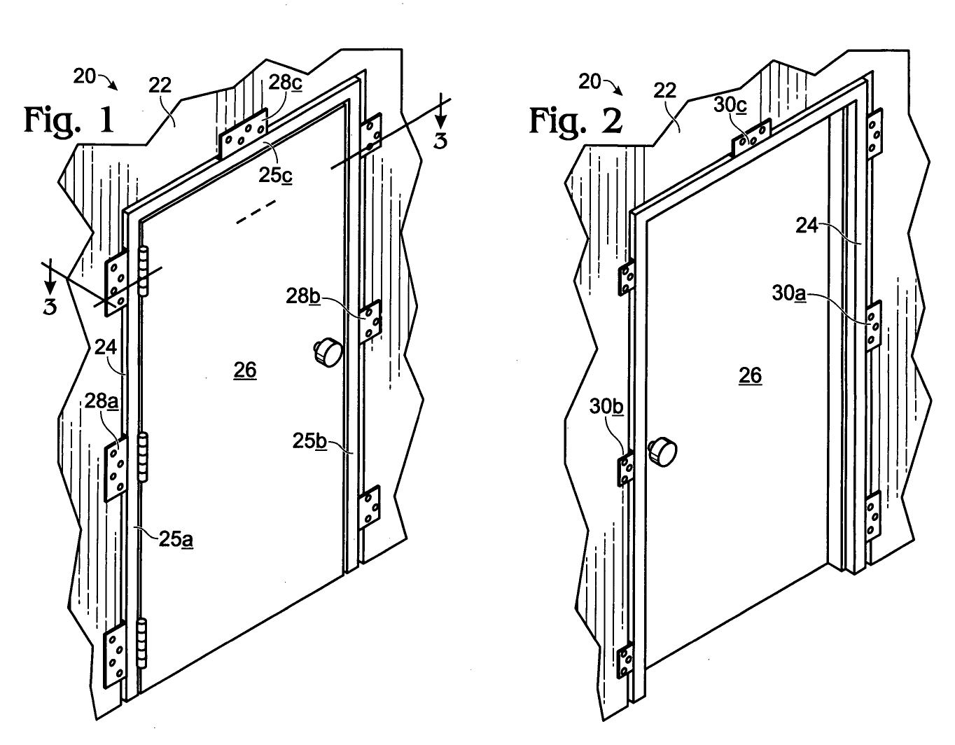

In FIG. 1, fire-resistant door jamb system 20 is installed in an opening in wall 22. Jamb 24 includes three main components: hinge leg 25a, strike leg 25b, and header 25c. Door 26 is supported by jamb 24. Jamb 24 is secured to wall 22 via brackets, namely, hinge leg brackets 28a, strike leg brackets 28b and header bracket 28c. As shown in FIG. 2, a complementing set of brackets 30a, 30b, 30c are used to attach jamb 24 on the back side of wall 22. In a preferred example, the front side hinge leg brackets 28a are 5-inches long. The other front and back side brackets are 3-inches long. The front side hinge leg brackets are larger because they may be relied on to provide crucial support to the door, via the hinges, during a fire situation. Other bracket shapes, sizes and numbers may also be used. For example, instead of these brackets per leg per side, one continuous long bracket may be used.

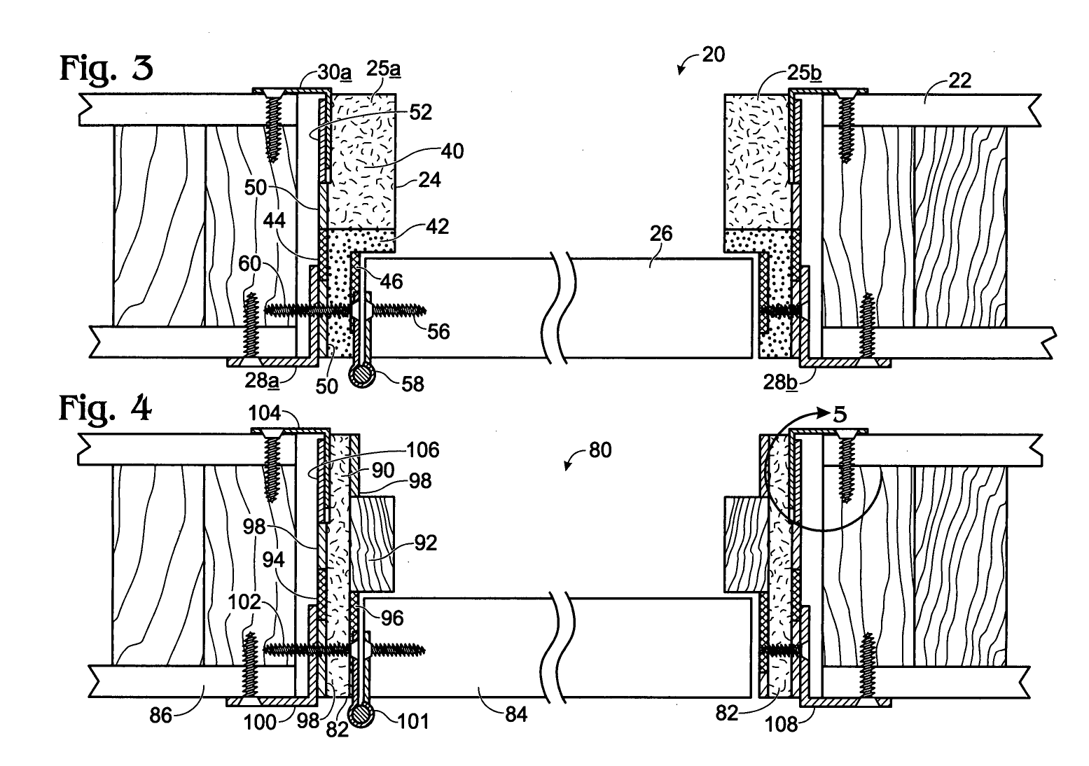

FIG. 3 shows a cross section through jamb system 20 illustrating details relating to fastening and securing of the jamb within the wall opening. Jamb 24 includes low grade wood portion 40, which may be made, for example, of an inexpensive finger-jointed wood material such as pine, cherry, oak, maple or TECTONITE® diatomaceous earth material. Wood portion 40 is connected to TECTONITE® diatomaceous earth component 42. Intumescent strips or sheets 44 and 46 are secured on opposite sides of jamb 24. Hard board composite sheets 50 may also be used on the back side of jamb 24 for the purpose of increasing screw-holding capacity.

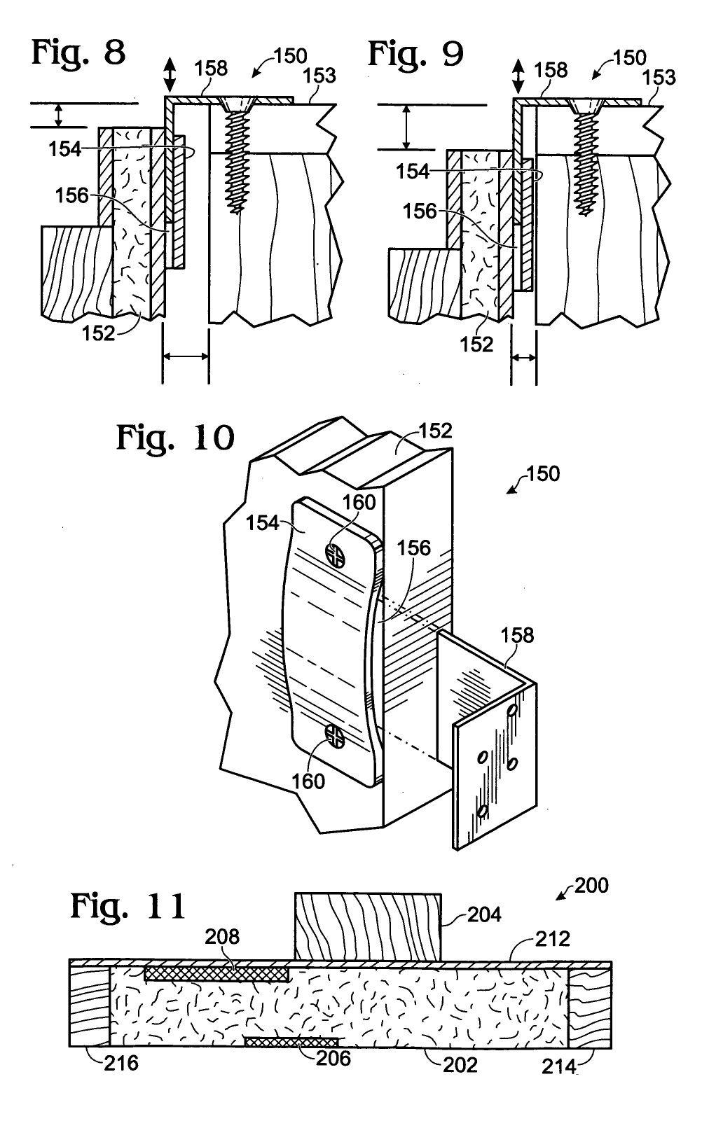

Fixed metal brackets 52 may be secured to the back side of jamb 24 by screws (not shown) to create a pocket for receiving adjustable brackets 30a. In the example shown in FIG. 3, the fixed bracket is installed in a recess in the back of jamb 24. In other examples the fixed bracket may be attached to the surface of the jamb without any recess (see FIGS. 8-10). Screws 56 are used to secure hinge 58 to door 26. Screws 60 secure hinge 58 to jamb 24 and extend further into wall 22, providing increased strength to the doorjamb system, even during a fire when the door, jamb and wall may be in a deteriorated state. For each hinge-leg bracket three screws may be used to secure the bracket to the jamb prior to installing the jamb in the wall. The jamb is pre-drilled with holes for securing the hinges. Prior to attaching the hinge to the jamb, a drill is used to cut holes in the metal bracket in-line with the pre-drilled hinge holes. Relatively long screws are then screwed in through the hinge, jamb and wall. Doorjamb system 20, as shown in FIG. 3, has been tested and received a 90-minute fire rating. In this application a timed fire rating means that the door/jamb system has been tested using a standard procedure conducted by a widely used and accepted agency such as Interteck Testing Services (ITS) or Underwriters Laboratories. Fire rating experiments referred to in this application were performed by an ITS engineer at an ITS Laboratory.

FIG. 4 shows another example of a fire-rated door. Door jamb system 80 has been tested and received a 60-minute firing rating. Door jamb system 80 is similar in many respects to door jamb system 20. However, door jamb system 80 does not include any diatomaceous earth component such as 42 in FIG. 3.

As shown in FIG. 4, jamb 82 supports door 84 within an opening in wall 86. Base portion 90 is preferably made of a fire-resistant particle board. For example, a preferred fire-resistant particle board is available from Spanolux under the trademark SPANO ANTIVLAM®. Wood stop member 92 is mounted on base portion 90. Intumescent strips 94 and 96 are mounted on opposite sides of base portion 90. Hard board composite layers 98 may also be used on the back side of jamb 82 primarily for increasing screw-holding capacity. Front bracket 100 is used to secure the front side of jamb 82 to wall 86, and also to strengthen the connection between door 84 to wall 86 via hinge 101 and long screws 102. Adjustable bracket member 104 is received in a pocket created by fixed metal bracket component 106. Similar jamb construction and bracketing system is used on the strike leg. However, as shown in FIG. 4, fixed bracket 108 is secured to jamb 82, but not to any hinge or door 84. Brackets 108 are preferably 3-inches long, whereas brackets 100 are 5-inches long.

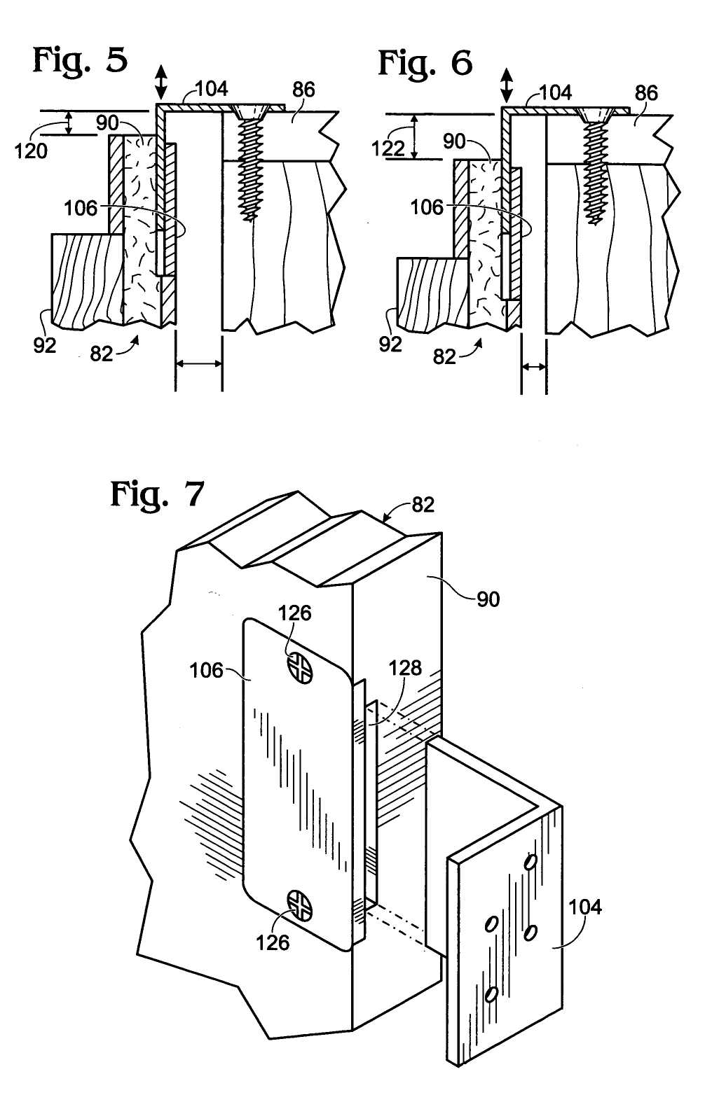

FIGS. 5 and 6 focus on adjustable brackets used to secure the back side of jamb 82 to wall 86, as shown in FIG. 2. A pocket is created on the outside of jamb 82 by fixed metal plate 106. Note that plate 106 is screwed (shown in FIG. 7) to base portion 90. Adjustable bracket member 104 may slide to a variable extent in the pocket to accommodate walls of different thickness. FIGS. 5 and 6 show the same bracket system being used to fasten jamb 82 to walls of different thickness. Distance 120 in FIG. 5 is smaller than distance 122 in FIG. 6, representing the differences in wall thickness, i.e., the wall in FIG. 5 is thicker than the wall in FIG. 6.

FIG. 7 shows a partial perspective view of adjustable bracket 104 in relation to pocket 128. Fixed metal plate 106 is fastened to base portion 90 via screws 126, thereby creating pocket 128 for receiving adjustable bracket 104.

FIGS. 8-10 show an alternative adjustable bracket system. As shown in FIG. 8, bracket system 150 connects the jamb 152 to the back side of wall 153. Fixed curved, or stepped plate number 154 is attached to jamb 152, as shown in FIG. 10. The curvature in fixed curved plate 154 creates pocket 156 for receiving adjustable bracket member 158. FIGS. 8 and 9 show adjustable bracket member 158 extending to different extents in pocket 156 to accommodate walls of different thickness.

FIG. 10 shows a partial perspective view of bracket system 150 prior to inserting adjustable bracket member 158 into pocket 156. As shown in FIG. 10, screws 160 attach plate member 154 to the surface of jamb 152 without any recess.

FIG. 11 shows an alternative fire-resistant door jamb configuration which has received a 60-minute fire rating. Jamb system 200 includes base portion 202, made preferably of a fire-resistant particle board. For example, base portion 202 may be a particle board composition including fire-resistant chemicals such as mono ammonium phosphate, mono potassium phosphate, other fire-resistant chemicals, or mixtures thereof. Wood stop member 204 is attached to base portion 202. Intumescent sheets 206 and 208 are attached to opposite sides of base portion 202. For example, an intumescent product known as PALUSOL 100 may be used. Wood veneer layers 212 are attached to the inside of base portion 202 so that the visible portions of jamb system 200, after installation, appear to be solid wood. Wood end portions 214 and 216 may also be attached to base portion 202 for the same purpose.

A door jamb kit may come with two legs and one header. The kit also may include a bracket system for installing the jamb in a wall opening. In general, the hinge leg may have a front face bracket corresponding to each door hinge. Further, a slot bracket and rear slide bracket is provided corresponding to each front face bracket. The strike leg may have the same number of brackets as the hinge leg or may have a different number. The brackets on the strike leg may be smaller because they support less load compared to the hinge leg. The header may have one or more sets of brackets, i.e., one front face bracket, one slot bracket, and one rear slide bracket.

As explained in more detail below, the front face brackets are intended to mount the front of the jamb flush with one side of the wall. Once the front face brackets are secured, then the corresponding rear slide brackets are inserted in respective slot brackets so that the rear slide brackets mount on the rear corner of the wall opening. The rear side brackets are then attached to the wall via screws. Accordingly, the rear slide brackets do not fix or secure the front-to-back position of the jamb in a wall opening, however, they assist in securing the doorjamb relative to up-down and side-to-side movement across the wall opening. The slide characteristic of the bracket permits installation of the jamb in walls of varying thickness.

The jamb systems described above permit a simple and straight forward method of installing a jamb. The bracket systems may have broad application to jamb systems even outside of the market for fire-resistant constructions. Generally, the legs and header are supplied unassembled. In some instances, the legs and header are supplied with mounting brackets pre-attached. In other instances, for example, if the jamb needs to be treated or painted prior to mounting, then the legs and header are supplied without pre-attaching the brackets. If necessary, the installation process is initiated by securing the brackets to the legs and header. The brackets are attached on the hinge leg at locations corresponding to the door hinges. The brackets may come with holes pre-drilled. Alternatively, the brackets may come without pre-drilled holes, in which case a jamb kit may include an appropriate drill bit for drilling holes in the brackets. The jamb legs may be provided with holes predrilled for attaching the door hinges.

Once the brackets are mounted on the legs and header, then the legs and header are laid down on the floor with the header away from the opening. Four screws are then used to attach the header to the legs. The jamb is then lifted up into the wall opening.

The installer then levels and attaches the hinge leg in the opening by screwing the front faced brackets into the face of the wall. Preferably, the top hinge bracket is secured before the bottom hinge bracket. Next, the header is leveled to be perpendicular with the hinge leg. The front face bracket on the header is then screwed into the wall. The installer then levels and secures the strike leg by screwing the brackets to the front face of the wall.

Once all sides of the jamb are appropriately level and positioned properly, then all of the screws on the front side are secured and tightened. A spreader bar may also be provided in the jamb kit for assisting with proper positioning and leveling of legs and header in the wall opening. The installer then secures the rear face of the jamb by inserting the rear slide brackets into respective slot brackets and screwing the slide brackets into the rear face of the wall. Once the jamb is secured in the opening, then the door is hung. The hinges for the door are attached to the inside of the hinge leg by driving the hinge screws through the corresponding front face brackets. This technique helps to maintain the position of the door during a fire even if wood components around the hinges partially combust or degrade.

While the present invention has been particularly shown and described with reference to the foregoing preferred examples, those skilled in the art will understand that many variations may be made without departing from the spirit and scope of the invention as variously described and defined above. The description of the invention should be understood to include all novel and non-obvious combinations of elements described herein.

For example, the basic jamb constructions described above including fire-resistant components and/or intumescent materials may be used in conjunction with conventional fastening hardware. Conversely, aspects of the innovative bracket systems described herein may be used to readily install other types of jambs, for example, even jambs that are not necessarily designed to resist fire.

Modified bracket systems may be used. For example, varying numbers of brackets may be used to attach a jamb to a wall. One or more brackets may be used on each leg and header. For some applications it may be preferable to use one long continuous bracket instead of multiple brackets. It may also sometimes be desired to use fixed brackets on both the front and back sides of the jamb instead of sliding brackets on the back side.

We claim:

1. A fire-resistant jamb system comprising
a hinge leg, a strike leg and a header, the header having a first end and a second end, the hinge leg being connected to the first end of the header, and the strike leg being connected to the second end of the header, and
each of the legs and header being comprised of wood and including a stop portion for contacting a door when the door is closed within the jamb, and at least a first intumescent strip running substantially the entire length of the leg or header.

2. The fire-resistant jamb system of claim 1 wherein the intumescent strip is positioned between a door and a wall when the jamb is installed in the wall and the door is in a closed position.

3. The fire-resistant jamb system of claim 1, wherein each leg and header has a base portion and at least a second intumescent strip, the first and second strips being positioned on opposite sides of the base portion.

4. The fire-resistant jamb system of claim 3, wherein each of the first and second intumescent strips is positioned at least partially between a door and a wall when the jamb is installed in a wall and the door is in a closed position.

5. The fire-resistant jamb system of claim 4, wherein each of the legs and header has recesses dimensioned to receive the first and second intumescent strips.

6. The fire-resistant jamb system of claim 1, each of the legs and header having a base portion comprised of fire-resistant particle board.

7. The fire-resistant jamb system of claim 6, wherein the particle board comprises mono ammonium phosphate, or mono potassium phosphate.

8. The fire-resistant jamb system of claim 1, each of the legs and header has a base portion comprised of diatomaceous earth.

9. The fire-resistant jamb system of claim 1, further comprising
a fire-resistant door connected to the hinge leg via hinges.

10. The fire-resistant jamb system of claim 9, wherein the hinges are connected to the jamb via one or more screws that penetrate the jamb and wall.

11. The fire-resistant jamb system of claim 1, wherein the jamb system configuration has 60 minute standard fire rating.

12. The fire-resistant jamb system of claim 1, wherein the jamb system configuration has a 90 minute standard fire rating.

13. The fire-resistant jamb system of claim further comprising
a bracket system for securing the legs and header in a wall opening.

14. A fire-resistant jamb system comprising
a jamb assembly including a hinge leg, a strike leg and a header, the header having a first end and a second end, the hinge leg being connected to the first end of the header, and the strike leg being connected to the second end of the header,
each of the legs and header being comprised of wood and including a stop portion for contacting a door when the door is closed within the jamb, and
a bracket set, wherein each of the legs and the header has a front side, a back side, an inside, and an outside, the bracket set including at least one fixed bracket and one adjustable bracket for each leg and header configured to secure the jamb assembly in a wall opening.

15. The fire-resistant jamb system of claim 14, further comprising
a fire-resistant door attached to the hinge leg via at least one hinge, the hinge being attached to the hinge leg by one or more screws that also pass through a fixed bracket attaching the hinge and the hinge leg to the wall.

16. The fire-resistant jamb system of claim 14, wherein each of the hinge leg and the strike leg has at least three fixed brackets and thee adjustable brackets.

17. The fire-resistant jamb system of claim 14, wherein a fixed slot is provided for each adjustable bracket, the slot being provided on the inside of the respective leg or header for receiving the respective adjustable bracket to a variable extent depending on the thickness of the wall.

18. A fire-resistant jamb system comprising
a jamb assembly including a hinge leg, a strike leg and a header, the header having a first end and a second end, the hinge leg being connected to the first end of the header, and the strike leg being connected to the second end of the header,
each of the legs and header being comprised of wood and fire-resistant material and including a stop portion for contacting a door when the door is closed within the jamb, and
a bracket set, wherein each of the legs and the header has a front side, a back side, an inside, and an outside, the bracket set including at least one fixed bracket configured to secure the hinge leg to the wall, and to receive one or more screws that also secure one or more door hinges to the hinge leg of the jamb assembly.
